(19) United States
(12) Patent Application Publication
(10) Pub. No.: US 2025/0363423 A1
(43) Pub. Date: Nov. 27, 2025

(54) EXCHANGE MODELER USING AN EXCHANGE PROTECTION ARCHITECTURE

(71) Applicant: Wells Fargo Bank, N.A., San Francisco, CA (US)

(72) Inventors: Catherine Wangari Mwangi, Hackensack, NJ (US); Nikhil Gopal Ratnam, San Francisco, CA (US)

(73) Assignee: Wells Fargo Bank, N.A., San Francisco, CA (US)

(21) Appl. No.: 18/671,714

(22) Filed: May 22, 2024

(51) Int. Cl. G06N 20/20

(52) U.S. Cl. CPC G06N 20/20

(57) ABSTRACT

Systems, methods, and computer-readable storage media for exchange modeling. One system includes a processing circuit. The processing circuits includes one or more processors and memory storing instructions that, when executed, cause the processing circuit to train a plurality of protection models of an entity using a training input to output a plurality of protection responses. The instructions further cause the processing circuit to receive exchange data of an exchange of a first entity. The instructions further cause the processing circuit to model, using an entity protection model, the exchange data and third-party data to generate an entity protection response. The instructions further cause the processing circuit to model, using at least one of an entity relationship model or an entity sector model, to generate at least one strategy response. The instructions further cause the processing circuit to receiving a feedback response to the entity protection response or the strategy response.

### BACKGROUND

In a computer networked environment, users and entities like individuals or companies, may desire to model data to improve protection policies and exchanges.

### SUMMARY

Some arrangements relate to a method, including training, by one or more processors, a plurality of protection models of an entity using a training input to output a plurality of protection responses. In some arrangements, the training can include receiving a plurality of entity datasets of a plurality of entities, the plurality of entity datasets corresponding to one or more protection parameters for at least one of the plurality of entities. The training can further include generating an entity protection model of the plurality of protection models to generate a plurality of entity protection responses for a plurality of exchanges, the entity protection model trained using, as a first input, the one or more protection parameters of a first entity of the plurality of entities. The training can further include generating one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities. The training can further include generating one or more entity sector models of the plurality of protection models to generate a plurality of second strategy responses, the one or more entity sector models trained using, as a third input, a second subset of entities of the plurality of entities satisfying a sector parameter or a cross-sector parameter. The method can further include receiving, by the one or more processors, exchange data of an exchange of the first entity of the plurality of entities. The method can further include modeling, by the one or more processors using the entity protection model, the exchange data and third-party data to generate an entity protection response corresponding to the exchange. The method can further include providing, by the one or more processors, the entity protection response corresponding to the exchange to an entity computing system of the first entity. The method can further include receiving, by the one or more processors, a feedback response to the entity protection response from the entity computing system. The method can further include updating, by the one or more processors, the entity protection model based on the feedback response. The method can further include updating, by the one or more processors, at least one of the one or more entity relationship models or the one or more entity sector models based on the feedback response.

In some arrangements, the method further including modeling, by the one or more processors using the one or more entity relationship models, the one or more protection parameters of the first entity to generate a first strategy response corresponding with a first update to the one or more protection parameters and providing, by the one or more processors, the first strategy response to the entity computing system.

In some arrangements, the method further including modeling, by the one or more processors using the one or more entity sector models, the one or more protection parameters of the first entity to generate a second strategy response corresponding with a second update to the one or more protection parameters and providing, by the one or more processors, the second strategy response to the entity computing system.

In some arrangements, the method further including receiving, by the one or more processors, a model creation request corresponding with the first entity, capturing and accessing, by the one or more processors using a plurality of data channels of the first entity, protection information and security information of the first entity, identifying, by the one or more processors, the one or more protection parameters of the first entity based on the protection information and security information of the first entity, and wherein the first input used in training of the entity protection model further includes the protection information and security information.

In some arrangements, the one or more protection parameters correspond to entity governance rules, protection management rules, security compliance standards, and operational integrity protocols of the first entity.

In some arrangements, the entity protection response is a protection index corresponding to a quantification of security vulnerabilities of the exchange.

In some arrangements, the method further including receiving, by the one or more processors, additional exchange data of a second exchange of the first entity of the plurality of entities, modeling, by the one or more processors using the updated entity protection model, the additional exchange data and the third-party data to generate a second entity protection response corresponding to the second exchange, and providing, by the one or more processors, the second entity protection response corresponding to the second exchange to the entity computing system of the first entity.

In some arrangements, providing includes at least one of transmitting, using a first communication protocol, the entity protection response to a webhook of a third-party application of a third-party and transmitting, using a second communication protocol, the entity protection response to an event listener of the third-party application of the third-party and loading the entity protection response into a shared storage system for retrievable by a pooling system of the third-party.

In some arrangements, the feedback response further includes an additional information request, and wherein the method further including generating, using a generative AI (GAI) model, a GAI response including an entity protection response report based on inputting the entity protection response, the exchange data, and the third-party data, wherein the GAI response is based at least on inputting the exchange data and the third-party data into at least one of the one or more entity relationship models or the one or more entity sector models.

Some arrangements relate to a system including a processing circuit including one or more processors and memory storing instructions that, when executed, cause the processing circuit to train a plurality of protection models of an entity using a training input to output a plurality of protection responses. In some arrangements, training can includes receiving a plurality of entity datasets of a plurality of entities, the plurality of entity datasets corresponding to one or more protection parameters for at least one of the plurality of entities. Training can further include generating an entity protection model of the plurality of protection models to generate a plurality of entity protection responses for a plurality of exchanges, the entity protection model trained using, as a first input, the one or more protection parameters of a first entity of the plurality of entities. Training can further include generating one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities. Training can further include generating one or more entity sector models of the plurality of protection models to generate a plurality of second strategy responses, the one or more entity sector models trained using, as a third input, a second subset of entities of the plurality of entities satisfying a sector parameter or a cross-sector parameter. The instructions can further cause the processing circuit to receive exchange data of an exchange of the first entity of the plurality of entities. The instructions can further cause the processing circuit to model, using the entity protection model, the exchange data and third-party data to generate an entity protection response corresponding to the exchange. The instructions can further cause the processing circuit to provide the entity protection response corresponding to the exchange to an entity computing system of the first entity. The instructions can further cause the processing circuit to receive a feedback response to the entity protection response from the entity computing system. The instructions can further cause the processing circuit to update the entity protection model based on the feedback response. The instructions can further cause the processing circuit to update at least one of the one or more entity relationship models or the one or more entity sector models based on the feedback response.

In some arrangements, the instructions further cause the processing circuit to model, using the one or more entity relationship models, the one or more protection parameters of the first entity to generate a first strategy response corresponding with a first update to the one or more protection parameters and provide the first strategy response to the entity computing system.

In some arrangements, the instructions further cause the processing circuit to model, using the one or more entity sector models, the one or more protection parameters of the first entity to generate a second strategy response corresponding with a second update to the one or more protection parameters and provide the second strategy response to the entity computing system.

In some arrangements, the instructions further cause the processing circuit to receive a model creation request corresponding with the first entity, capture and access, using a plurality of data channels of the first entity, protection information and security information of the first entity, identify the one or more protection parameters of the first entity based on the protection information and security information of the first entity, and wherein the first input used in training of the entity protection model further includes the protection information and security information.

In some arrangements, the one or more protection parameters correspond to entity governance rules, protection management rules, security compliance standards, and operational integrity protocols of the first entity.

In some arrangements, the entity protection response is a protection index corresponding to a quantification of security vulnerabilities of the exchange.

In some arrangements, the instructions further cause the processing circuit to receive additional exchange data of a second exchange of the first entity of the plurality of entities, model, using the updated entity protection model, the additional exchange data and the third-party data to generate a second entity protection response corresponding to the second exchange and provide the second entity protection response corresponding to the second exchange to the entity computing system of the first entity.

In some arrangements, providing includes at least one of transmitting, using a first communication protocol, the entity protection response to a webhook of a third-party application of a third-party, transmitting, using a second communication protocol, the entity protection response to an event listener of the third-party application of the third-party, and loading the entity protection response into a shared storage system for retrievable by a pooling system of the third-party.

In some arrangements, the feedback response further includes an additional information request, and wherein the instructions further cause the processing circuit to generating, using a generative AI (GAI) model, a GAI response including an entity protection response report based on inputting the entity protection response, the exchange data, and the third-party data, wherein the GAI response is based at least on inputting the exchange data and the third-party data into at least one of the one or more entity relationship models or the one or more entity sector models.

Some arrangements relate to a method, including training, by one or more processors, a plurality of protection models of an entity using a training input to output a plurality of protection responses. Training the protection models can include receiving, by the one or more processors, exchange data of an exchange of a first entity of a plurality of entities. The method can further include modeling, by the one or more processors using an entity protection model, the exchange data and third-party data to generate an entity protection response corresponding to the exchange. The method can further include modeling, by the one or more processors using at least one of an entity relationship model or an entity sector model, the exchange data and third-party data to generate a strategy response. The method can further include providing, by the one or more processors, the entity protection response and the strategy response corresponding to the exchange to an entity computing system of the first entity. The method can further include receiving, by the one or more processors, a feedback response to the entity protection response or the strategy response from the entity computing system. The method can further include updating, by the one or more processors, at least one of the entity protection model, the entity relationship model, or the entity sector model, based on the feedback response.

In some arrangements, training further includes receiving a plurality of entity datasets of the plurality of entities, the plurality of entity datasets corresponding to one or more protection parameters for at least one of the plurality of entities, generating the entity protection model of the plurality of protection models to generate a plurality of entity protection responses for a plurality of exchanges, the entity protection model trained using, as a first input, the one or more protection parameters of the first entity of the plurality of entities, generating the one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities, and generating the one or more entity sector models of the plurality of protection models to generate a plurality of second strategy responses, the one or more entity sector models trained using, as a third input, a second subset of entities of the plurality of entities satisfying a sector parameter or a cross-sector parameter.

### BRIEF DESCRIPTION OF THE DRAWINGS

FIG. 1 is a block diagram depicting an example of an exchange protection architecture, according to some arrangements.

FIG. 2 is a block diagram illustrating an example computing system suitable for use in the various arrangements described herein.

FIG. 3 is a block diagram further illustrating the exchange protection architecture, according to some arrangements.

FIG. 4 is a flowchart for a method of exchange modeling, according to some arrangements.

FIG. 5 is a block diagram of an example system using supervised learning, according to some arrangements.

FIG. 6 is a block diagram of a simplified neural network model, according to some arrangements.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the figures, systems, apparatuses, methods, and non-transitory computer-readable media for exchange modeling are described herein. In various technological ecosystems, efficiently processing and synthesizing vast amounts of information from disparate sources poses significant challenges. Organizations often struggle to integrate this data promptly and effectively, especially when it comes to enacting comprehensive operational policies. Existing systems may conduct initial checks during client onboarding, but fail to leverage this data for subsequent operations, for example, in complex structures like subsidiaries that may not be wholly owned or are thinly held. Thus, existing ecosystems may result in a technical problem of integrating and utilizing vast datasets effectively within their operational frameworks.

The implementations described herein address the technical problem by providing enhanced data integration and analysis capabilities, which deliver a particular technical solution that streamlines and refines data processing workflows across various operational activities. The systems and methods described herein are implemented to improve how data is synthesized and utilized across various organizational processes. By integrating data related to market conditions, cash flows, and specific transactional details into multiple models, these systems and methods provide dynamic evaluations that adapt to changes in client activities and market conditions. For example, the implementations can provide continuous re-evaluations of conditions as transactions occur across various accounts of clients, subsidiaries, and other related entities. Accordingly, this approach provides a specific technical improvement to various technical problems, including those set forth herein.

The improved exchange protection system can facilitate the implementation of policies directly within the operational workflow, leveraging data analytics to proactively enforce compliance and operational strategies. By applying machine learning models, the systems and methods can detect patterns and predict outcomes based on a large amount of data inputs, such as relationship data and balance sheets. This can improve evaluations such that models are not only based on initial screenings but are continuously updated, trained, and provided to organization which maintains compliance and manages operational effectiveness. Accordingly, the models trained and implemented herein provide technological improvements over existing business ecosystems by providing real-time, adaptive response mechanisms that tailor operational strategies based on current data insights. That is, these improvements are realized by implementing real-time data integration and dynamic interpretation, enhancing both the speed and accuracy of operational responses. For example, lack of real-time data integration is a technical problem in existing technological ecosystems, which is solved by implementing adaptive machine learning models, a technical solution.

In some arrangements, the systems and methods can act as intermediaries that assess real-time transactions to improve compliance with established policies. For example, if a transaction with a subsidiary triggers a compliance breach due to fluctuating commodity prices, the systems and methods can immediately adjust the operational strategy to initiate required processes. These models can identify vulnerabilities and security issues in transactions and can also be configured to suggest actionable strategies for enhancing operational efficacy. By analyzing transactional and third-party data, such as credit ratings and market conditions, the systems and methods can generate recommendations for strategic adjustments before or after transactions occur.

Generally, the models described herein can be trained on data including internal organizational data, transaction-specific data, and broader market data. Over time, the models can learn from ongoing interactions and market changes, refining their predictions and recommendations. In some arrangements, continuous learning can be supported by a person-in-the-loop system, where human oversight can guide the initial training and ongoing adjustment of models. Additionally, clients can benefit from benchmarks against industry standards, which can be generated by the systems and methods from accumulated data on similar transactions handled by comparable clients. In some arrangements, the systems and methods can use generative AI (GAI) to adapt and create new models based on new or emerging patterns not previously identified.

Generally, the systems and methods described herein can receive, for a plurality of clients, information related to one or more policies (e.g., protection parameters) for a respective client (e.g., entity, user, corporation). In some arrangements, the systems and methods can include generate a client model (e.g., protection model) to compute scores for transactions and generate additional models (e.g., commonality and/or industry model(s)). That is, the client model can be generated by applying the information related to the one or more policies as a training input. Furthermore, a commonality model (e.g., relationship model) can be generated according to the client model for a first subset of clients which have one or more matching traits. Moreover, an industry model (e.g., sector model) can be generated according to the client model for a second subset of clients which share a common industry. In some arrangements, once the various models are trained and implemented, the systems and methods described herein can receive, for a first client, data corresponding to a transaction of the first client. In response to receiving the transaction (or exchange), the systems and methods can calculate a score (e.g., level assessment, vulnerability score, or risk score) for the transaction using the client model (e.g., unique to the client of the transaction) based on applying the transaction data and third-party data from third-party data sources related to the transaction to the client model as an input. Additionally, the client can be transmitted the score and in response, can provide a response to the score. In some arrangements, based on the response the client model can be updated and at least one of the client commonality model or the industry model can be updated.

In some arrangements, the systems and methods described herein can provide a recommendation for improving exchange oversight (e.g., enhancing security measures, strengthening compliance protocols, implementing preventive controls, mitigating risk, bolstering data protection strategies) associated with transactions, where the recommendation can be derived from insights trained and implemented through the industry model or client commonality model. For example, upon the successful onboarding of a new client, the systems and methods may generate a client-specific model that can be used to evaluate potential risks in transactions. Additionally, discrepancies or differences between this newly created client model and existing commonality models may be identified and communicated to the client. In some arrangements, after the initial protection assessment, data for subsequent transactions can be processed to calculate updated exchange scores using the refined client model. For example, the exchange scores can be transmitted or provided to third-party services via a webhook (or any other type/form of data integration tool/resource which is configured to push/pull data between disparate data sources). Furthermore, based on the calculated score, a specific client device can be selected for receiving reports and further interactions. In some arrangements, upon receiving a feedback response to the score, which may include requests for additional details regarding the risk assessment, the systems and methods can employ a generative AI model to provide a summary of the score and evaluation. For example, the summary could incorporate data analyzed through the client commonality model or industry model. In some arrangements, continuous data acquisition from multiple streams may be integrated into the systems and methods.

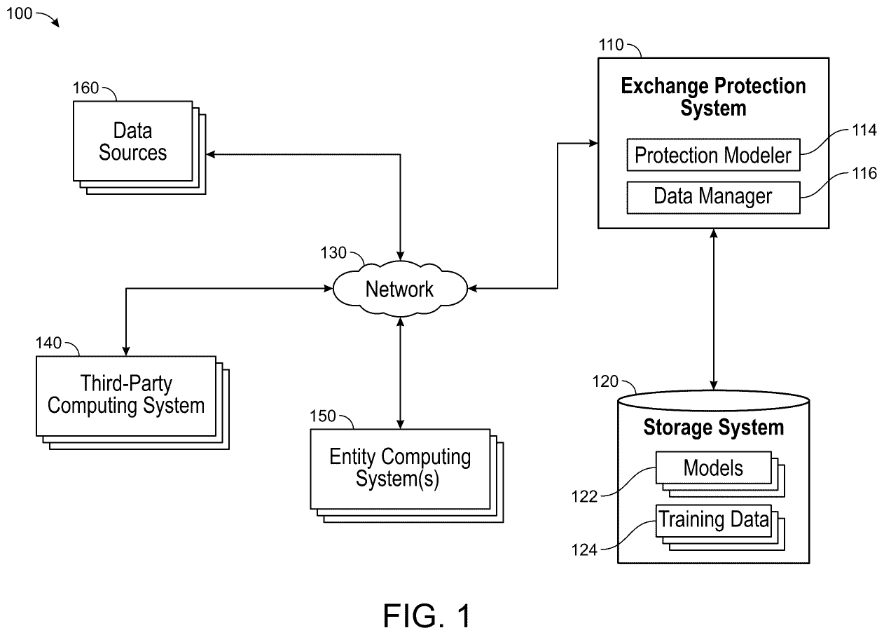

Referring now to FIG. 1, a block diagram depicting an example of an exchange protection architecture 100 is shown, according to some arrangements. Exchange protection architecture 100 includes exchange protection system 110, third-party entity computing systems 140, entity computing systems 150, and data sources 160. In various arrangements, components of exchange protection architecture 100 communicate over network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In various arrangements, network 130 facilitates secure communication between components of exchange protection architecture 100. As a non-limiting example, network 130 may implement transport layer security (TLS), secure sockets layer (SSL), hypertext transfer protocol secure (HTTPS), and/or any other secure communication protocol.

The network 130 can facilitate communication between various nodes, such as the exchange protection system 130, third-party entity computing system 140, entity computing system 150, and data sources 160. In some arrangements, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6. The network 130 can be composed of various network devices (nodes) communicatively linked to form one or more data communication paths between participating devices. Each networked device includes at least one network interface for receiving and/or transmitting data, typically as one or more data packets. An illustrative network 130 is the Internet; however, though other types or forms of networks may be used. The network 130 may be an autonomous system (AS), e.g., a network that is operated under a consistent unified routing policy (or at least appears to from nodes/operators/devices outside the AS network) and is generally managed by a single administrative entity (e.g., a system operator, administrator, or administrative group).

The data sources 160 can provide data to the exchange protection system 110. In some arrangements, the data sources 160 can be structured to collect data from other devices on network 130 (e.g., third-party entity computing system 140 and/or entity computing system 150) and relay the collected data to the exchange protection system 110. In one example, an entity (e.g., users, businesses, and so on) may have, maintain, or otherwise manage one or more server(s) which include, maintain, or otherwise store a database (e.g., proxy, enterprise resource planning (ERP) system). The database may include or store account data, protection parameters, exchange data, vendor data, other entity data, and/or payment information associated with the user and/or entity. In this example, the exchange protection system 110 may request third-party of the database (e.g., data sources 160) associated with an exchange or transaction. For example, in some arrangements, the data sources 160 can host or otherwise support a search or discovery engine for Internet-connected devices. The search or discovery engine may provide data to the exchange protection system 110. In some arrangements, the data sources 160 can be scanned to provide additional data (e.g., third-party data used in training and modeling). The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases, generative artificial intelligence (GAI) data, and/or any other intelligence data associated with a specific entity, common entities, or sector/industry entities.

Generally, the exchange protection system 110, third-party entity computing system 140, and entity computing system 150 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions may include code from various programming languages commonly used in the industry, such as high-level programming languages, web development languages, and systems programming languages. The exchange protection system 110, third-party entity computing system 140, and entity computing system 150 may also include one or more databases for storing data, such as storage system 120, that receives and provides data to other systems and devices on the network 130.

Entity computing system 150 (sometimes referred to herein as a “mobile device”, “user device”, or “client device”) may be a cloud computing system, desktop computing system, mobile computing device, smartphone, tablet, smart watch, smart sensor, or any other device configured to facilitate receiving, displaying, and interacting with content (e.g., web pages, mobile applications, etc.). That is, the entity computing system 150 can be associated with an entity that corresponds with a trained entity protection model of the exchange protection system 110. For example, the entity can be a financial institution specializing in high-value asset transactions. In another example, the entity can be an energy company with various subsidiaries, each subsidiary having unique protection parameters but also share some protection parameters of the parent company. In this example, the energy company can implement tailored risk management strategies across its subsidiaries while maintaining overarching compliance with industry regulations. Entity computing system 150 can also provide training data and exchange data to the exchange protection system 110. For example, the training data can include protection information and security information. In another example, the exchange data can include transaction data detailing the time, amount, and parties involved in each transaction. The entity computing system 150 can include an application to receive and display content and to receive user interaction with the content (e.g., recommendations and protection responses by modeler 114). For example, the application may be a web browser. Additionally, or alternatively, the installed application may be a mobile application. The entity computing system 150 can communicate data over network 130 (e.g., receive and transmit training data and exchange data to exchange protection system 110).

The third-party entity computing system 140 (sometimes referred to herein as a “mobile device”, “user device”, or “vendor device”) may be a cloud computing system, desktop computing system, mobile computing device, smartphone, tablet, smart watch, smart sensor, or any other device configured to facilitate receiving, displaying, and interacting with content (e.g., web pages, mobile applications, etc.). For example, the third-party entity corresponding to the third-party entity computing system 140 can be a market research entity or financial institution that can provide additional insights in modeling exchanges and providing recommendations and scores/indices. In some examples, the third-party may be a credit rating agency corresponding with financial assessments. In some examples, the third-party entity may also be a customer of the provider. Third-party entity computing system 140 can also provide third-party data for training and modeling to the exchange protection system 110. For example, the third-party data can include historical transaction records and credit assessments. In another example, the third-party data can include industry-specific economic indicators and benchmarking data. The third-party entity computing system 140 can include an application to receive and display content and to receive user interaction with the content (e.g., recommendations and protection responses generated by modeler 114). For example, the application may be a web browser. Additionally, or alternatively, the installed application may be a mobile application. The entity computing system 140 can communicate data over network 130 (e.g., receive and transmit training data and exchange data to exchange protection system 110).

Both the third-party entity computing system 140 and the entity computing system 150 can provide data and be accessed by the exchange protection system 110 using an enterprise resource. In some arrangements, the enterprise resource can be an enterprise resource planning (ERP) system or other enterprise resource that can analyze and manage data flows between systems. For example, the enterprise resource may be configured to facilitate data integration and automation across the organization's operations. In another example, the enterprise resource may be configured to support data security and compliance efforts by monitoring data access and usage.

Generally, the exchange protection system 110 can be or include a trained model and data acquisition system configured to model and automate the collection, processing, and analysis of transaction data and third-party information to generate predictive insights and protection (or risk) assessments. The exchange protection system 110 can interact with the various systems of exchange protection architecture 100 over network 130. In some arrangements, the exchange protection system 110 can include one or more processing circuits including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language. In some arrangements, the exchange protection system 110 can include a modeler 114 and data manager 116.

The exchange protection system 110 may be a server, distributed processing cluster, cloud processing system, combination of cloud and edge processing systems, or any other computing device. Exchange protection system 110 may include or execute at least one computer program or at least one script. In some implementations, exchange protection system 110 includes combinations of software and hardware, such as one or more processors configured to execute one or more scripts. Exchange protection system 110 is shown to include storage system 120 (e.g., database, cloud storage). Storage system 120 may store received data. That is, the storage system 120 can include, maintain, or otherwise store the received data in connection with various models 122. For example, models 122 can be or include the entity protection models, entity relationship models, and entity sector models. Additionally, the storage system 120 can include training data 122 for training models 122. For example, the training data can include protection parameters of entities, protection information and security information of entities, third-party data of entities, and so on. In some implementations, the storage system 120 may be integrated with the exchange protection system 110. In some implementations, the storage system 120 can exist as a distinct component accessible to the exchange protection system 110, the third-party entity computing system 140, and/or entity computing system 150 via the network 130. The storage system 120 can also be distributed throughout protection architecture 100. For example, the storage system 120 can include multiple databases associated with the exchange protection system 110, the third-party entity computing system 140, and/or entity computing system 150. Storage system 120 may include one or more storage mediums. The storage mediums may include but are not limited to magnetic storage, optical storage, flash storage, and/or RAM. Exchange protection system 130 may implement or facilitate various APIs to perform database functions (i.e., managing data structures 122 stored in storage system 120). The APIs can be but are not limited to SQL, ODBC, JDBC, NOSQL and/or any other data storage and manipulation API.

Generally, the protection modeler 114 (sometimes referred to herein as a “machine learning (ML) system”) can be an artificial intelligence (AI) system that is trained to generate protection indices (e.g., risk scores) and strategies (e.g., recommendations). The protection modeler 114 can be configured to use stored training data 124 to train, generate, implement, and/or re-train models 122. The protection modeler 114 can be configured to train, retrain, and implement models to provide improved responses using entity and third-party data stored in the storage system 120. That is, generally, a vendor, entity, or third-party may store entity governance rules, protection management rules, security compliance standards, and operational integrity protocols of the first entity, market data, cash flow information, exchange data, relationship data, and account and balance sheet data.

In some arrangements, the protection modeler 114 can be configured to train and implement entity protection models using machine learning techniques. For example, in response to receiving, for a plurality of clients, information related to one or more policies for a respective client, the protection modeler 114 can generate for each client, a client model (e.g., entity protection model) to compute risk scores for transactions. In this example, the client model can be generated by applying the information related to the one or more policies as a training input. That is, the protection modeler 114 can process and analyze datasets includes policies of the entity, historical exchange data, and third-party data, such as market trends and regulatory compliance information. The entity protection model can be trained to predict risks and generate risk scores based on the characteristics of each transaction. That is, the entity protection model can be unique to each entity such that the policies and rules of the entity will be used to train the entity protection model to provide responses. In some arrangements, the protection modeler 114 can integrate the trained models into an operational environment of the exchange protection system 110, where the model can be executed to analyze real-time transaction data. That is, the protection modeler 114 can continuously monitor and assess exchanges, providing dynamic risk scoring. For example, the entity protection model can receive a stream of transaction data and third-party market information, apply the trained model to this data, and generate a risk score that indicates potential security or compliance issues. In another example, model parameters can be updated in real-time as new data is accessed or received. In some arrangements, the entity protection model could be, but is not limited to, a generative AI (GAI) ML model, a predictive analytics ML model, a decision tree ML model, a cluster analysis ML model, or a neural network.

In some arrangements, the protection modeler 114 can transmit the risk score for the transaction to a device corresponding to a specific client (e.g., entity computing system 150). For example, the risk score (e.g., protection response) can be displayed as a dashboard alert or sent as a notification to enhance decision-making processes regarding the transaction. In some arrangements, the protection modeler 114 can receive a response to the risk score from the device. The response can be a feedback response that can be used to re-train the model. For example, the feedback can indicate the provide score or data was satisfactory or helpful. In another example, the feedback can be a request for further detailed analysis or an adjustment in the risk scoring parameters. The protection modeler 114 may be configured to apply the feedback response as another training input, to retrain the protection modeler 114. In this regard, the protection modeler 114 may be configured to adapt both to various training inputs, including both policies and regulations of the corresponding to the entity and feedback on risk scores of individual transactions of the entity.

In some arrangements, the protection modeler 114 can be configured to train and implement entity relationship models using machine learning techniques. That is, the relationship models can be trained to identify and predict the dynamics of entity interactions based on shared or related attributes. For example, the protection modeler 114 can generate one or more client commonality models (e.g., entity relationship models) according to the client model for a first subset of clients (e.g., entities) which have one or more matching traits. The models can use the datasets containing attributes such as governance policies and historical interaction data to train models to identify patterns and suggest strategic interactions. Machine learning techniques that can be utilized might include clustering algorithms like K-means or hierarchical clustering to group entities with similar risk profiles or interaction patterns. Upon training, the protection modeler 114 can implement (e.g., deploy) the relationship models into a live environment where the models can analyze ongoing entity interactions. For example, the entity protection model can receive exchange data and/or third-party data to calculate or determine a risk score for the transaction for a specific client. That is, the entity protection model can applying the data corresponding to the transaction and third-party data from one or more third-party data sources related to the transaction to the client model as an input. In some arrangements, the protection modeler 114 can be re-trained and provide updated recommendations based on current data flows. For example, protection modeler 114 can process incoming transaction data to predict and alert on potential compliance violations or security threats in real-time. Additionally, the relationship model can adjust its parameters autonomously in response to new data, such that the entity relationship model can remain accurate over time, such as by refining cluster definitions as new entities are onboarded or as transaction patterns change. In some arrangements, the entity relationship model could be, but is not limited to, a generative AI (GAI) ML model, a predictive analytics ML model, a decision tree ML model, a cluster analysis ML model, or a neural network.

In some arrangements, the protection modeler 114 can be configured to train and implement entity sector models using machine learning techniques. That is, the sector models can be trained to identify and generate recommendations for policy changes, product enhancements, or service improvements. For example, the protection modeler 114 can generate one or more industry models (e.g., entity sector models) according to the client model for a second subset of clients which share a common industry. The training process can include receiving datasets that include protection parameters such as compliance standards and operational protocols across different industry sectors. Machine learning algorithms can be employed to handle the diverse and imbalanced datasets. For implementation, protection modeler 114 integrates these models into the operational environment where they function in real-time to evaluate transactions and identify sector-specific risks. For example, in the financial sector, the model could detect patterns indicative of fraudulent transactions by comparing current transaction data against historical fraud data. In another example, in the healthcare sector, the model can assess risks based on compliance with new privacy regulations. In some arrangements, the entity sector model could be, but is not limited to, a generative AI (GAI) ML model, a predictive analytics ML model, a decision tree ML model, a cluster analysis ML model, or a neural network.

In some arrangements, the data manager 116 can be configured to interact with third-party entity computing systems 140, entity computing systems 150, and/or data sources 160 to obtain, validate, and store data within the training data 124, or to train or re-train models 122. This can include the initial acquisition of data in addition to ongoing monitoring and updating of data, to reflect real-time or near real-time changes (e.g., in protection parameters or third-party data). The data manager 116 can be configured to update the data used by the protection modeler 114 in modeling is current, accurate, and comprehensive. In some arrangements, the data manager 116 can pull or access the latest protection information and security information of entities, third-party, and incorporate additional data that could impact models responses (e.g., outputs). Additionally, the data manager 116 can interact with social media and news feeds to incorporate external data that could impact risk score generation or recommendations (e.g., stored on data sources 160).

In some arrangements, the data manager 116 can generate and update training data 124 of storage system 120, which is configured to securely maintain a training data of the various models 122. This training data can include information related to one or more policies for a respective client (e.g., protection parameters). For example, the policies could include transaction compliance procedures providing adherence to international trade regulations. In another example, the policies could include guidelines for performing due diligence and risk assessment when initiating exchanges with new partners. In yet another example, the policies could include protocols for monitoring ongoing transactions to detect and respond to any fraudulent activities.

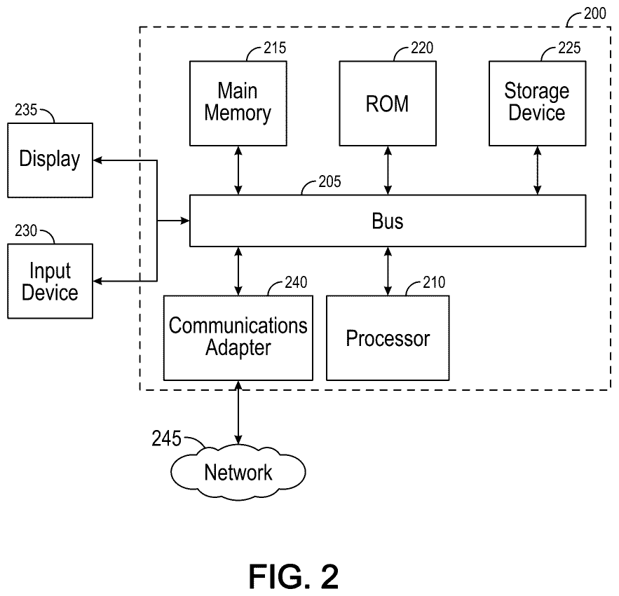

Referring now to FIG. 2, a depiction of a computer system 200 is shown. The computer system 200 that can be used, for example, to implement a computing environment (e.g., exchange protection architecture 100), the exchange protection system 110, the third-party computing systems 140, the entity computing systems 150, the data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to facilitate communications with a computing or communications network 245 (similar features and functionality as network 130) and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, virtual server. In various arrangements, computing system 200 may share physical storage, hardware, and other resources with other virtual machines. In some arrangements, virtual resources of the network may include cloud computing resources such that a virtual resource may rely on distributed processing across more than one physical processor, distributed memory, etc.

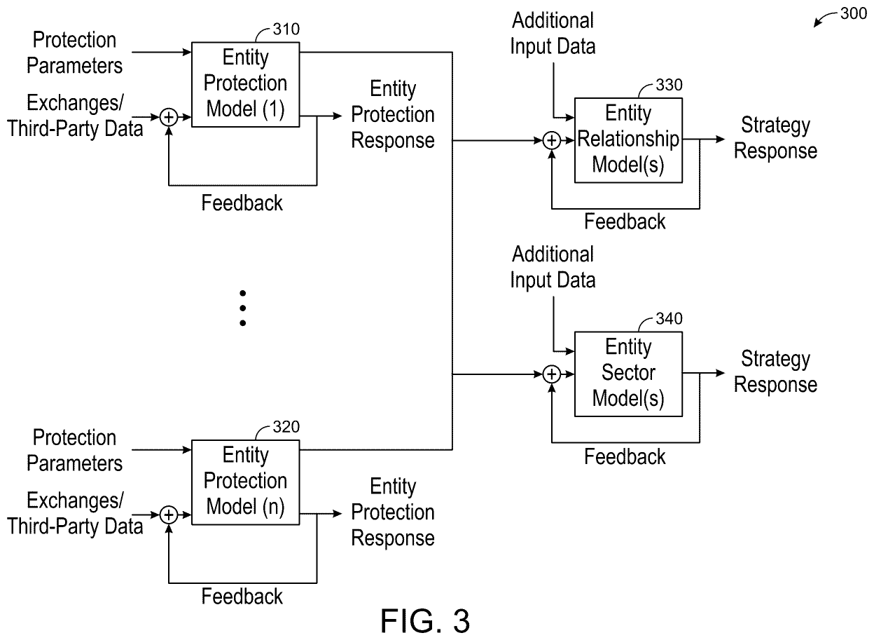

Referring now to FIG. 3, a block diagram further illustrating the exchange protection architecture, according to some arrangements. The exchange protection architecture including the exchange protection system 110 of FIG. 1 can be configured to train and implement models. In some arrangements, the protection modeler 114 can train and implement entity protections models 310 and 320, entity relationship model 330, and entity sector model 340.

In some arrangements, the entity protection model 310 can be trained on protection parameters of a specific entity. For example, the protection parameters can include, but is not limited to, entity governance rules, protection management rules, security compliance standards, and operational integrity protocols of the specific entity. Generally, the entity protection model 310 can be a machine-learning model or another type of artificial intelligence model such as, but not limited to, deep learning models, neural network models, or ensemble learning models. Training of the entity protection model 310 can include inputting training data (e.g., protection parameters and other data such as exchanges and third-party data) to train the model to output an entity protection response (e.g., protection index, or risk score corresponding with a particular exchange). That is, training can include analyzing patterns in transaction data to refine risk scoring algorithms. For example, training the entity protection model 310 can include applying regression analysis to forecast potential vulnerabilities. In this example, the entity protection model 310, unique to the specific entity, updates its predictions based on continuous learning from transaction outcomes and feedback (e.g., feedback from the output or the entity).

Additionally, the entity protection model 310 can be implemented once training is complete. For example, training of the entity protection model 310 may complete responsive to outputs from the entity protection model 310 satisfying a training criteria. The training criteria may be or include risk scores computed by the entity protection model 310 being within a predetermined threshold of actual or perceived risk associated with a corresponding training input. As another example, the training criteria may be or include the entity protection model 310 successfully identifying training inputs labeled as associated with risky transactions, as compared to training inputs labeled as associated with non-risky transactions. Implementing the entity protection model 310 can include deploying the model into a live or active computing environment. The live or active computing environment can receive exchanges or alerts of exchanges by the specific entity and model the exchange with third-party data (e.g., market data, cash flow information, relationship data, account and balance sheet data) to output (or generate) an entity protection response. The entity protection response can be a protection index or risk score corresponding to a quantification of security vulnerabilities of the exchange. That is, the protection index quantifies the risk level in real-time, providing immediate information and decision-making for entities. For example, the implemented entity protection model 310 can receive data from or corresponding to a vendor exchange, model the vendor exchange and the third-party data, and generate an output indicating the risk level and suggesting mitigation strategies. Accordingly, implementing the entity protection model 310 can include automating response mechanisms to mitigate identified risks dynamically.

The entity protection model 320 can include similar features and functionalities as entity protection model 310, however, the entity protection model 320 can be trained and implemented for a different entity (e.g., user, client, customer, corporation). In some arrangements, the protection parameters (e.g., entity governance rules, protection management rules, security compliance standards, and operational integrity protocols of the different entity) can reflect the unique regulatory and operational needs of the different entity. Training and implementing can be similar to the entity protection model 310 but, customized to account for specific risk factors and compliance requirements of the second entity. That is, instead of a broad universal model, the entity protection model 320 is trained and implemented on specific threats and vulnerabilities relevant to that entity. For example, the entity protection model 320 can be trained on entity-specific datasets to better understand entity-specific risks. In this example, the entity protection model 320 can be implemented for the different entity such that it provides customized risk assessments and response strategies.

In some arrangements, the entity relationship model 330 can be trained on protection parameters of entities and additional input data (e.g., previous entity protection responses, third-party data, exchange data, etc.). The entities may be selected from a plurality of entities based on common attributes or equivalent attributes of a first subset of entities. For example, the common attributes could be a governance policy regarding data privacy. In another example, an equivalent attribute could be entity A having exchange policy Y and entity B having exchange policy Z, but both exchange policy Y and exchange policy Z are directed to mitigate similar risks. The entity relationship model 330 can be a commonality model that can analyze and integrate these attributes to provide risk assessments. Generally, the entity relationship model 330 can be a machine-learning model or another type of artificial intelligence model such as, but not limited to, deep learning models, neural network models, or ensemble learning models. Training of the entity relationship model 330 can include inputting training data (e.g., protection parameters of multiple entities and the additional input data) to train the model to output a strategy response (e.g., recommendation, risk mitigation strategies, or policy adjustments). That is, training can include pattern recognition and anomaly detection to identify emerging risks. For example, training the entity relationship model 330 can include utilizing clustering algorithms to group entities with similar risk profiles. In this example, the entity relationship model 330, unique to a group of common entities, can provide proactive adjustments to policies and practices across entities.

Additionally, the entity relationship model 330 can be implemented once training is complete (similar to the entity protection model(s) 310). Implementing the entity relationship model 330 can include deploying the model into a live or active computing environment. The live or active computing environment can receive exchanges or alerts of exchanges by the entities and model the exchange to output (or generate) a strategy response. The strategy response can be a recommendation corresponding to actions or steps the entity can implement to enhance security measures or compliance. That is, the recommendation can inform targeted interventions based on predicted risk levels. For example, the implemented entity relationship model 330 can receive a vendor exchange, model the vendor exchange and the additional data, and generate an output suggesting specific contractual adjustments to enhance vendor compliance. For example, the implemented entity relationship model 330 can receive (e.g., irrespective of an exchange occurring) protection parameters of a specific entity and model the entities protection parameters and the additional data, and generate a specific recommendation for a product or service to improve transaction security measures. In yet another example, the implemented entity relationship model 330 can receive (e.g., irrespective of an exchange occurring) protection parameters of a specific entity and model the entities protection parameters and the additional data, and generate a specific policy update based on detected vulnerabilities in governance policies. Accordingly, implementing the entity relationship model 330 can include automated updates to risk assessments and policy recommendations.

In some arrangements, the entity sector model 340 can be trained on protection parameters of entities and additional input data (e.g., previous entity protection responses, third-party data, exchange data, etc.). The entities may be selected from a plurality of entities satisfying a sector parameter or a cross-sector parameter. For example, all entities of the financial sector (e.g., sector parameter) can be identified and selected. In another example, all entities of multi-sector compliance with GDPR (cross-sector parameter) can be identified and selected. The entity sector model 340 can be an industry model that can provide sector-specific risk assessments and compliance guidelines. Generally, the entity sector model 340 can be a machine-learning model or another type of artificial intelligence model such as, but not limited to, deep learning models, neural network models, or ensemble learning models. Training of the entity sector model 340 can include inputting training data (e.g., protection parameters of multiple entities and the additional input data) to train the model to output a strategy response (e.g., recommendation, customized controls, or regulatory alignment). That is, training can include utilizing predictive analytics to forecast sector-specific threats. For example, training the entity sector model 340 includes applying deep learning techniques to understand patterns across sectors. In this example, the entity sector model 340, unique to a group of industry entities, optimizes compliance and risk management strategies.

Additionally, the entity sector model 340 can be implemented once training is complete. Implementing the entity sector model 340 can include deploying the model into a live or active computing environment. The live or active computing environment can receive exchanges or alerts of exchanges by the entities and model the exchange to output (or generate) a strategy response. The strategy response can be a recommendation corresponding to actions or steps the entity can implement to address specific sector challenges, unique to the particular sector. That is, the recommendation can include actionable steps tailored to the sector's unique risk landscape. For example, the implemented entity sector model 340 can receive a vendor exchange, model the vendor exchange and the additional data, and generate an output suggesting best practices for mitigating supply chain risks. For example, the implemented entity sector model 340 can receive (e.g., irrespective of an exchange occurring) protection parameters of a specific entity and model the entities protection parameters and the additional data, and generate a specific recommendation for a product or service to improve sector-specific exchange security defenses based on the industry standard. In yet another example, the implemented entity sector model 340 can receive (e.g., irrespective of an exchange occurring) protection parameters of a specific entity and model the entities protection parameters and the additional data, and generate a specific policy update based on emerging regulatory requirements. Accordingly, implementing the entity relationship model 330 can include dynamic response mechanisms to adapt to changing sector conditions.

In some arrangements, each of the models (e.g., entity protection models 310 and 320, entity relationship models 330 and entity sector models 340) can also use the outputs (e.g., entity protection response or strategy response) as feedback into the model to re-train and optimize the models. For example, the entity protection response can be used as feedback to the entity protection model 310 to adjust risk scoring algorithms based on real-world outcomes. In another example, the entity protection response and a feedback response (e.g., from the client) can be used as feedback to the entity protection model 320 to refine predictive accuracy and sensitivity to specific types of exchanges. In yet another example, the entity protection response can be used as feedback to the entity relationship model 330 to enhance relationship mapping and detection of interconnected risks. In yet another example, the entity protection response can be used as feedback to the entity sector model 340 to update sector-specific threat models and compliance requirements. In some arrangements, the incorporation of the feedback as input to re-train the model provides continuous learning and improvement of the system's predictive framework.

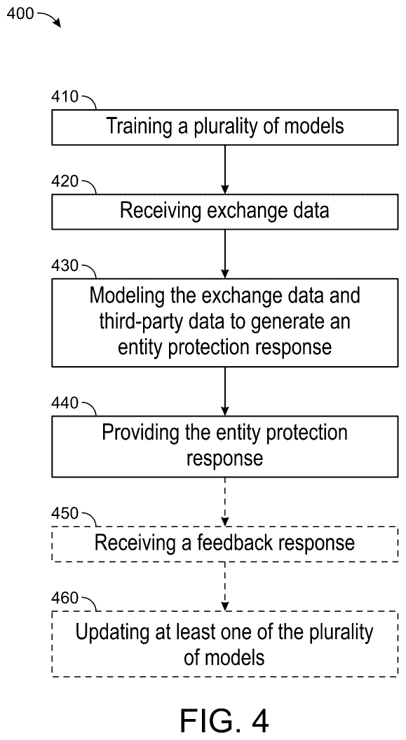

Referring now to FIG. 4, a flowchart for a method 400 of exchange modeling is shown, according to some embodiments. The computing systems and nodes of FIG. 1 can be configured to perform method 400. Further, any computing device described herein can be configured to perform method 400.

In broad overview of method 400, at block 410, the one or more processing circuits can train a plurality of models. At block 420, the one or more processing circuits can receive exchange data. At block 430, the one or more processing circuits can model the exchange data and third-party data to generate an entity protection response. At block 440, the one or more processing circuits can provide the entity protection response. At block 450, the one or more processing circuits can receive a feedback response. At block 460, the one or more processing circuits can update at least one of the plurality of models. Additional, fewer, or different operations may be performed depending on the particular arrangement. In some arrangements, blocks can be optionally executed (e.g., blocks depicted as dotted lined) by the one or more processors. In some arrangements, other blocks (e.g., non-dotted lined) may be optionally executed. Additional, fewer, or different operations may be performed depending on the particular arrangement. In some embodiments, some, or all operations of method 400 may be performed by one or more processors executing on one or more computing devices, systems, or servers. In various embodiments, each operation may be re-ordered, added, removed, or repeated.

At block 410, the one or more processing circuits can train a plurality of protection models of a respective entity, using training inputs, to output a plurality of protection responses. In some arrangements, the protection models can be customized entity models or general models (e.g., commonality model, sector model). The protection responses can be a protection index quantifying a security vulnerability of performing an exchange (e.g., with another entity). For example, the protection index could be a threat level assessment, vulnerability score, or risk score. That is, the protection index can provide a risk score for each transaction, calculated based on the entity's policies for managing relationships with distributors, vendors, etc. In some arrangements, the protection index can inform decision-making on whether to proceed with, modify, or cancel a transaction based on the calculated risk. That is, a training input to provide a response would utilize the entity's policies as a framework to evaluate each exchange's risk, offering a tailored risk score for specific transactions. Generally, an input can be the specific policy parameters relevant to the transaction and a response can be the computed risk assessment or index for that particular exchange or transaction.

In some arrangements, training can include receiving a plurality of entity datasets of a plurality of entities. The plurality of entities datasets may correspond to one or more protection parameters for at least one of the plurality of entities. The protection parameters can be entity governance rules, protection management rules, security compliance standards, and operational integrity protocols of the first entity. That is, the plurality of entity datasets can be used to train AI models to recognize and adapt to different exchanges/transactions based on policies, requirements, and/or compliance frameworks of different entities. For example, a protection parameter could be how an exchange is to be processed with a vendor. In another example, a protection parameter could be exchange policies with unauthorized distributors. In another example, a protection parameter could be governance policy for handling communications and exchanges with a governmental entity. In some arrangements, the processing circuits can identify or interpolate protection parameters from the entity datasets to train and learn from the data, improving the model's capability to predict exchange vulnerabilities and risks accurately.

Referring generally to generating models, the processing circuits can utilize machine learning techniques to build predictive models. In some arrangements, model generations include feature selection to identify the relevant data points for analysis. Furthermore, model generations include cross-validation where the models can generalize unseen data. In some arrangements, the model can be a decision tree model, a neural network model, a support vector machine model, or a random forest model. For example, to generate a decision tree model, the processing circuits can use training data to recursively split nodes based on information gain. In another example, to generate a neural network model, the processing circuits can train layers of neurons to recognize patterns and make predictions. In some arrangements, model generation can include human-in-the-loop where humans review and adjust the model outputs for accuracy and reliability. That is, adjustments are made based on an analysis to fine-tune the model before deployment. For example, a security analysts might analyze the model's predictions on phishing attacks.

In some arrangements, training can further include generating an entity protection model of the plurality of protection models to generate a plurality of entity protection responses for a plurality of exchanges. That is, the entity protection model can be trained using, as an input, the one or more protection parameters of a first entity of the plurality of entities. Generally, generating an entity protection model can include developing one or more customized model that specifically address the security and compliance needs of the entity. That entity protection model can be unique or specific to each entity, such that responses are customized to entity-specific parameters. That is, responses can be tailored based on each entity's operational context and risk profile. Furthermore, model generation includes training the model with historical data and updating it with real-time feedback. For example, training on past exchange incidents to predict future vulnerabilities or fraudulent exchanges. Furthermore, the input can be used in generation by incorporating live data streams to continuously improve the model's predictive accuracy. For example, using real-time transaction monitoring to adjust risk scores dynamically.

Still at block 410, in some arrangements, training can further include generating one or more entity relationship models of the plurality of protection models to generate a plurality of first strategy responses. That is, the one or more entity relationship models can be trained using, as an input, a first subset of entities of the plurality of entities based on a common attribute or an equivalent attribute of the first subset of entities. For example, a common attribute can be data access control policies. In another example, an equivalent attribute could be network security protocols. That is, while not the same, an equivalent attribute can be identified by comparing their respective roles in safeguarding sensitive information and preventing unauthorized access. An equivalent attribute can be quantified by evaluating the degree to which different policies reduce risk, using metrics such as incident reduction percentage or compliance rate improvements. Generally, attributes of a subset of an entity can be compared to attributes of other entity subsets such that common governance policies and exchange policies and compliance needs can be identified and addressed collectively. Generating an entity relationship model can include analyzing transaction patterns and relationship networks between entities. The entity relationship model can be common to a plurality of entities sharing attributes, such that responses are aligned to optimize collective security strategies. That is, cooperative approaches to exchange security and cybersecurity can be implemented based on shared policies and threat intelligence. Furthermore, model generation can include applying clustering algorithms to group similar entities and customize exchange protocols. For example, using cluster analysis to determine shared policies among entities within the same industry. Furthermore, the input can be used in generation by aggregating data from multiple sources to provide a composite view of the threat landscape. For example, data can be synthesized from industry reports, internal logs, and cybersecurity feeds to enhance the model's outputs (e.g., responses).

In some arrangements, training can further include generating one or more entity sector models of the plurality of protection models to generate a plurality of second strategy responses. That is, the one or more entity sector models can be trained using, as an input, a second subset of entities of the plurality of entities satisfying a sector parameter or a cross-sector parameter. For example, a sector parameter can be financial services. In another example, a cross-sector parameter can be data privacy standards across sectors. Generally, parameters associated with the entities may be analyzed to customize risk assessments specific to industry standards and cross-sector challenges. Furthermore, the entities may be from different industries but may initiate international payments in Country X, perform numerous sensitive transactions, similar transaction profiles, or similar client size. For example, sector-specific risk mitigation strategies are formulated based on the unique sector challenges identified. That is, customized compliance frameworks can be recommended for entities within the same sector. Generally, generating an entity sector model can include integrating sector-specific regulatory requirements and historical data on compliance breaches using supervised learning models, which are designed for making predictions based on labeled data, or using methods that combine multiple machine learning models to improve prediction accuracy. That entity sector model can be common to a plurality of entities satisfying parameters, such that responses are standardized and adaptable to sector-specific attributes. That is, preventative measures and corrective actions can be calibrated according to sector-based risk profiles. Furthermore, model generation can include applying clustering techniques to identify patterns and anomalies across different sectors, enhancing the model's capability to provide relevant and actionable insights. For example, the outputs of the models can be used to adaptively recommend security enhancements based on threats identified through data analysis.

In some arrangements, prior to training an entity model, the processing circuits can receive a model creation request corresponding with the first entity. The model creation request can start an onboarding process to generate a new, entity-specific, entity model. That is, the process tailors the model specifically to evaluate transactional risks based on the entity's policy parameters. For example, setting up the model to prioritize and assess risks in financial transactions according to the entity's internal controls and compliance standards. In some arrangements, the processing circuits can capture and access, using a plurality of data channels of the first entity, protection information and security information of the first entity. Additionally, the processing circuits can identify the one or more protection parameters of the first entity based on the protection information and security information of the first entity. For example, the protection parameters (e.g., entity governance rules, protection management rules, security compliance standards, and operational integrity protocols of the first entity) can be extracted from the protection information and security information by systematically analyzing the documented policies and comparing them against regulatory benchmarks and past incident data. That is, the processing circuits can capture and access the data using secure data interfaces that aggregate and normalize policy-related data for analysis. In some arrangements, the data channels of the first entity can be, but is not limited to, security policy documents, compliance audit files, or user access control settings, where each channel can provide inputs for determining how policies influence risk levels in transactions. For example, the processing circuits can synthesize these inputs to create a framework for the risk assessment model, such that the model can reflect the specific security and compliance landscape of the entity. In some arrangements, the first input used in training of the entity protection model further includes the protection information and security information. That is, this data can further enrich the model, so that model can generate accurate and actionable risk scores for each transaction based on current and historical policy adherence and violations.

At block 420, the one or more processing circuits can receive exchange data of an exchange of the first entity of the plurality of entities. In some arrangements, prior, during, or before a transaction, the processing circuits can receive transaction data of the transaction. That is, the exchange data can include details such as transaction amounts, involved parties, and date and timestamps. For example, the exchange data can include logs of vendor interactions. In another example, the exchange data can include audit trails of user access during the transaction. Receiving exchange data can prompt or queue the exchange data for modeling.

At block 430, the one or more processing circuits can model, using the entity protection model, the exchange data and third-party data to generate an entity protection response corresponding to the exchange. For example, the third-party data could be, but is not limited to, market data, cash flow information, relationship data, account and balance sheet data, intellectual property information, compliance reports, industry trends, and competitive analysis data. That is, the third-party data can be analyzed to provide context and enhance the risk assessment accuracy. In one example, the third-party data could be credit rating information of a vendor that the exchange is being performed with. In some arrangements, the entity protection response can be a protection index (e.g., score, vulnerability likelihood, impact rating) corresponding to a quantification of security vulnerabilities of the exchange. That is, the index measures the potential risk and can provide suggestions mitigative actions. Additionally, the modeling of the exchange data and third-party data as input into the entity protection includes utilizing analytics to detect patterns and potential threats. In some arrangements, the entity protection model is trained and implemented to receive the exchange data and third-party data as input and dynamically update risk assessments based on the ongoing analysis.

In some arrangements, the processing circuits can model the exchange data and third-party data to generate an aggregate group response corresponding with a peer group index. That is, the peer group index can reflect the aggregated risk levels of similar entities or transactions for benchmarking purposes. For example, this can help in identifying industry-standard practices and deviations. Furthermore, while the entity protection model can be unique to the entity, an aggregate group response can be generated from modeling by leveraging data from similar entities to predict common vulnerabilities. Alternatively or in combination, the entity relationship model can generate the aggregate group response by identifying comparisons and synthesizing shared risk profiles. That is, strategies can be formulated to collectively enhance security across the group. For example, the processing circuits can implement cross-entity policies or security protocols.

Accordingly, the model can flag or identify potential fraudulent exchanges or vulnerabilities with the exchange on a per-exchange basis. For example, a potential fraudulent exchange could be an unusually high transfer of funds to a new vendor. In another example, a potential vulnerability with the exchange could be insufficient verification processes for high-value transactions. Using the entity protection model, unique to the entity, provides technological improvements to transaction monitoring and fraud detection systems. Furthermore, the technical problem of securing sensitive transactions against emerging threats is solved using the particular technological improvement of integrated data analytics and machine learning models by proactively identifying and addressing potential risks.

At block 440, the one or more processing circuits can provide the entity protection response corresponding to the exchange to an entity computing system of the first entity. In some arrangements, providing the protection response can include sending the calculated risk scores and detailed assessment reports via secure channels. For example, email notifications or system dashboard updates could be used to inform relevant stakeholders. Additionally, in some arrangements, providing can include transmitting, using a first communication protocol, the entity protection response to a webhook of a third-party application of a third-party. That is, the third-party application can be a risk management tool that is used by the user. The entity protection response could be presented as an alert or notification in the third-party application. For example, the first communication protocol could be HTTP (Hypertext Transfer Protocol). In this example, transmitting to a webhook can include authenticating and securely posting the data to the webhook URL. Moreover, in some arrangements, providing can include transmitting, using a second communication protocol, the entity protection response to an event listener of the third-party application of the third-party. For example, the second communication protocol could be WebSocket or secure API, where predefined API calls can be executed. In this example, transmitting to an event listener can include establishing a persistent connection for real-time data transmission. Furthermore, in some arrangements, providing can include loading the entity protection response into a shared storage system for retrievable by a pooling system of the third-party. For example, a pooling system of a third-party can include a cloud-based data lake. In this example, loading to a shared storage system can include encrypting and uploading the data for later retrieval and analysis.

At block 450, the one or more processing circuits can receive a feedback response to the entity protection response from the entity computing system. In some arrangements, the feedback response can be a determination by the entity if the entity protection response provided to the entity accurately reflects or captures the entities view, preferences, or if the entity desires to continue receiving entity protection responses similar to the one provided. That is, the feedback response can influence future risk assessment models and trigger adjustments to the parameters used in risk calculations. For example, the feedback response could be a request for more detailed analysis on certain risk factors. In another example, the feedback response could be suggestions for adjusting the risk threshold settings in the model. Thus, the feedback response can be used to refine the individual models of the entity by incorporating the feedback directly into the model training cycle to improve accuracy and relevancy. Furthermore, the iterative feedback loop can provide technological improvements in the model by fine-tuning the model to better align with the entity's operational realities and risk management policies.

In some arrangements, the feedback response can include an additional information request. For example, when an additional information request is provided by the entity, the processing circuits can generate, using a generative AI (GAI) model, a GAI response including an entity protection response report (or summary) based on inputting the entity protection response, the exchange data, and the third-party data into the GAI model. That is, the GAI model could be utilized to synthesize data sets into risk insights and forecasts. For example, the GAI response can highlight potential areas of risk concentration and propose preventative measures. In some arrangements, the GAI response can be based at least on inputting the exchange data and the third-party data into at least one of the one or more entity relationship models or the one or more entity sector models. That is, the report can include information obtained from the models. For example, the model's output can offer a comparative analysis showing risk levels against industry benchmarks. In another example, the report could provide scenario analysis outcomes to aid strategic decision-making.

At block 460, the one or more processing circuits can update the entity protection model based on the feedback response and update at least one of the one or more entity relationship models or the one or more entity sector models based on the feedback response. For example, the entity protection model can be updated based on the feedback response. In another example, at least one of the one or more entity relationship models or the one or more entity sector models can be updated based on the feedback response. Generally, updating a model can include incorporating the feedback response into the model training process. For example, updating the entity protection model (e.g., unique to a particular entity) can include providing the feedback response to retrain the model with the latest data and insights. That is, the model's parameters and algorithms can be refined based on the feedback. In another example, updating the entity relationship model (e.g., shared commonality model between common entities) can include providing the feedback response to adjust the model's clustering and relationship analysis. That is, fine-tuning the model's understanding of common governance policies and exchange patterns. In yet another example, updating the entity sector model (e.g., shared industry or sector model between entities of a similar industry or sector) can include providing the feedback response to enhance the model's sector-specific risk assessment parameters. That is, the model can be customized to better capture industry-specific threats and compliance requirements. Accordingly, the updated models can then be re-deployed or integrated into the operational workflow to provide updated outputs from risk assessments based on the latest feedback.

In some arrangements, after a model is updated, the processing circuits can receive additional exchange data of a second exchange of the first entity of the plurality of entities. The processing circuits can model, using the updated entity protection model, the additional exchange data and the third-party data to generate a second entity protection response corresponding to the second exchange. That is, the updated entity protection model can be fine-tuned to account for new data and insights. In some arrangements, the processing circuits can provide the second entity protection response corresponding to the second exchange to the entity computing system of the first entity. For example, the refined risk assessments can be communicated to the entity's systems to assist in decision-making.

In some arrangements, the processing circuits can model, using the one or more entity relationship models, the one or more protection parameters of the first entity to generate a first strategy response corresponding with a first update to the one or more protection parameters. That is, the first strategy response can be a recommendation to modify or mitigate a policy, procedure, or risk based on the commonality model (e.g., entity relationship models). For example, a protection parameter of the first entity can be a policy for managing potential risky or fraudulent transactions. In this example, the first update can be identified by the commonality model based on modeling the protection parameters (e.g., entity governance rules, protection management rules, security compliance standards, and operational integrity protocols of the first entity) and analyzing exchange patterns across entities with similar characteristics. In this example, the commonality model can identify an update to the policy based on the commonality model's understanding of industry norms and best practices. Furthermore, in this example, the first update could be suggested adjustments to transaction verification procedures or fraud detection mechanisms. That is, the commonality model (e.g., entity relationship model) can be trained and implemented to provide customized recommendations for policy improvements. Furthermore, modeling can also include modeling the third-party data (e.g., additional input data), with the protection parameters, to refine risk assessments and policy recommendations. For example, this can include incorporating market trends and vendor performance metrics into the analysis. Moreover, modeling can also include modeling the entity protection response (e.g., additional input data), with the protection parameters, to provide actionable insights for risk mitigation strategies. For example, this can include identifying specific areas of vulnerability in exchange processes and suggesting corresponding policy adjustments. In some arrangements, the processing circuits can provide the first strategy response (e.g., recommendation, instructions, guidance) to an entity computing system. For example, the processing circuits can transmit recommendations to an organization (e.g., prior to, during, or after the exchange).

Accordingly, the entity relationship model can facilitate collaborative risk management and exchange policy optimization among entities with similar profiles. For example, this can include identifying common risk factors and proposing collective risk mitigation strategies. In another example, this could include using shared insights and experiences to enhance overall exchange security and compliance. Using the relationship model, common to a group of entities, provides technological improvements to adaptive risk management and proactive policy adjustments. Furthermore, the technical problem of optimizing exchange policies and mitigating risks across multiple entities is solved using the particular technological improvement of collaborative modeling and policy recommendation by enhancing decision-making processes and reducing vulnerabilities.

In some arrangements, the processing circuits can model, using the one or more entity sector models, the one or more protection parameters of the first entity to generate a second strategy response corresponding with a second update to the one or more protection parameters. That is, the second strategy response can be a recommendation to modify or mitigate a policy, procedure, or risk based on the industry model (e.g., entity sector models). For example, a concentrated exposure can be identified of the entity based on the entity and subsidiaries all using a particular vendor where data privacy standards may be compromised. In this example, the concentrated exposure can be identified by the industry model based on modeling the protection parameters (e.g., entity governance rules, protection management rules, security compliance standards, and operational integrity protocols of the first entity) and analyzing sector-specific challenges and regulatory requirements. That is, the industry model (e.g., entity sector model) can be trained and implemented to identify sector-specific vulnerabilities and recommend corresponding policy adjustments. Furthermore, modeling can also include modeling the third-party data (e.g., additional input data), with the protection parameters, to enhance sector-specific risk assessments and policy recommendations. For example, this can include incorporating industry trends and regulatory updates into the analysis. Moreover, modeling can also include modeling the entity protection response (e.g., additional input data), with the protection parameters, to provide tailored risk management strategies for sector-specific challenges. For example, this can include recommending compliance frameworks and security protocols specific to the financial services sector. In some arrangements, the processing circuits can provide the second strategy response (e.g., recommendation, instructions, guidance) to an entity computing system. For example, this can include transmitting sector-specific policy recommendations to relevant stakeholders within the organization (e.g., prior to, during, or after the exchange).

Accordingly, the entity sector model can improve sector-wide risk management practices and compliance standards. For example, this can include identifying sector-specific vulnerabilities and recommending standardized risk mitigation strategies. In another example, this could include facilitating industry-wide collaboration and knowledge sharing to address common challenges and regulatory requirements. Using the sector model, common to a group of entities, provides technological improvements to sector-specific risk assessment and policy formulation. Furthermore, the technical problem of risk management practices across industries is solved using the particular technological improvement of sector-specific modeling and policy recommendation by enhancing sector-wide resilience and regulatory compliance.

In some arrangements, the processing circuits can model, using at least one of one or more entity relationship models or one or more entity sector models, the exchange data and third-party data to generate a strategy response. For example, modeling exchange data (e.g., transaction information) and third-party data can include analyzing transaction patterns and financial stability indicators from market data. In this example, the strategy response could be a recommendation to adjust transaction policies based on detected financial trends. In some arrangements, the processing circuits can model, using at least one of one or more entity relationship models or one or more entity sector models, protection parameters of the entity and third-party data to generate a strategy response. For example, modeling protection parameters (e.g., entity policies) and third-party data can include correlating governance compliance with external regulatory changes. In this example, the strategy response could be a recommendation to update internal controls to align with new regulatory standards. In some arrangements, the processing circuits can model, using at least one of one or more entity relationship models or one or more entity sector models, third-party data to generate a strategy response. For example, modeling third-party data can include assessing risk levels from industry benchmarks and economic indicators. In this example, the strategy response could be a recommendation to modify risk management strategies in response to sector volatility.

In some arrangements, the processing circuits can provide the entity protection response and the strategy response corresponding to the exchange to an entity computing system of the first entity. Additionally, the processing circuits can receive a feedback response to the entity protection response or the strategy response from the entity computing system. For example, the feedback response can be to the protection response (e.g., risk score) that acknowledges the accuracy of the score and expresses satisfaction with the insights provided. In another example, the feedback response can be to the strategy response (e.g., from one or both of the models) that commits to implementing the recommended operational adjustments or expresses concerns regarding the proposed strategy. In some arrangements, the processing circuits can update at least one of the entity protection model, the entity relationship model, or the entity sector model, based on the feedback response. That is, the models are refined to enhance predictive accuracy and alignment with the entity's operational preferences. For example, adjustments are made to the training datasets or model parameters to better reflect the entity's feedback and market conditions.

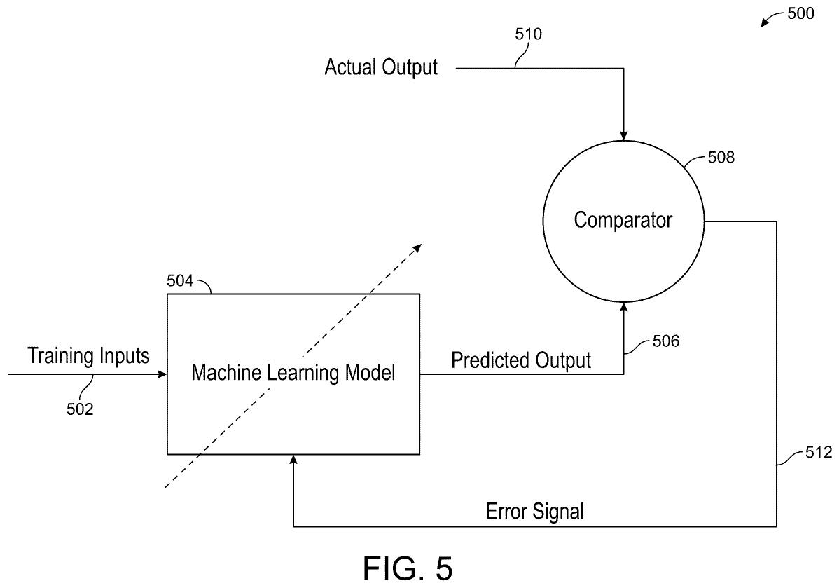

Referring to FIG. 5, a block diagram of an example system using supervised learning, is shown. Supervised learning is a method of training a machine learning model given input-output pairs. An input-output pair is an input with an associated known output (e.g., an expected output).

Machine learning model 504 may be trained on known input-output pairs such that the machine learning model 504 can learn how to predict known outputs given known inputs. Once the machine learning model 504 has learned how to predict known input-output pairs, the machine learning model 504 can operate on unknown inputs to predict an output.

The machine learning model 504 may be trained based on general data and/or granular data (e.g., data structures 122 stored in storage system 120) such that the machine learning model 504 may be trained specific to data structures 122.

Training inputs 502 and actual outputs 510 may be provided to the machine learning model 504. For example, training inputs 502 may include a first data structure including a first dataset.

The first dataset can include data of a plurality of entities, protection data, exchange data, and third-party data, and the like.

The inputs 502 and actual outputs 510 may be received from computing systems and data sources of FIG. 1. For example, a data repository may contain models and training data. Thus, the machine learning model 504 may be trained to generate protection responses and strategy responses with corresponding data items based on the training inputs 502 and actual outputs 510 used to train the machine learning model 504.

The exchange protection system 110 may include one or more machine learning models 504. In an embodiment, a first machine learning model 504 may be trained to generate protection responses. For example, the first machine learning model 504 may use the training inputs 502 to predict outputs 506, by applying the current state of the first machine learning model 504 to the training inputs 502. The comparator 508 may compare the predicted outputs 506 to actual outputs 510 (e.g., trends or previous protection responses or third-party data) to determine an amount of error or differences. For example, the predicted protection response (e.g., predicted output 106) may be compared to the actual protection scores (e.g., actual output 110).

In other embodiments, a second and third machine learning model may be trained to predict strategies or recommendations. For example, the second or third machine learning model may use the training inputs 502 to predict outputs 506, by applying the current state of the second or third machine learning model to the training inputs 502. The comparator 508 may compare the predicted outputs 506 to actual outputs 510 (e.g., reports) to determine an amount of error or differences.

The actual outputs 510 may be determined based on historic data of reports provided to the user 532 (e.g., entities). In an illustrative non-limiting example, actual outputs 510 could include policy information and third-party market data. In another illustrative non-limiting example, actual outputs 510 might include a record of entity feedback response decisions made by the entities based on the previously generated responses.

During training, the error (represented by error signal 512) determined by the comparator 508 may be used to adjust the weights in the machine learning model 504 such that the machine learning model 504 changes (or learns) over time. The machine learning model 504 may be trained using a backpropagation algorithm, for instance. The backpropagation algorithm operates by propagating the error signal 512. The error signal 512 may be calculated each iteration (e.g., each pair of training inputs 502 and associated actual outputs 510), batch and/or epoch, and propagated through the algorithmic weights in the machine learning model 504 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 504 may be tuned to reduce the amount of error, thereby minimizing the differences between (or otherwise converging) the predicted output 506 and the actual output 510. The machine learning model 504 may be trained until the error determined at the comparator 508 is within a certain threshold (or a threshold number of batches, epochs, or iterations have been reached). The trained machine learning model 504 and associated weighting coefficients may subsequently be stored in memory 516 or other data repository (e.g., a database) such that the machine learning model 504 may be employed on unknown data (e.g., not training inputs 502). Once trained and validated, the machine learning model 504 may be employed during a testing (or an inference phase). During testing, the machine learning model 504 may ingest unknown data to predict future data (e.g., responses of entities to different scores or recommendations, and the like).

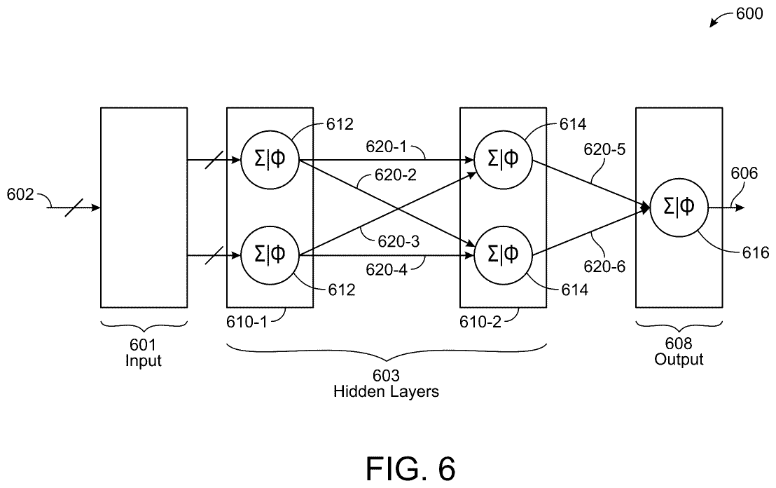

Referring to FIG. 6, a block diagram of a simplified neural network model 600 is shown. The neural network model 600 may include a stack of distinct layers (vertically oriented) that transform a variable number of inputs 602 being ingested by an input layer 604, into an output 606 at the output layer 608.

The neural network model 600 may include a number of hidden layers 610 between the input layer 604 and output layer 608. Each hidden layer has a respective number of nodes (612, 614 and 616). In the neural network model 600, the first hidden layer 610-1 has nodes 612, and the second hidden layer 610-2 has nodes 614. The nodes 612 and 614 perform a particular computation and are interconnected to the nodes of adjacent layers (e.g., nodes 612 in the first hidden layer 610-1 are connected to nodes 614 in a second hidden layer 610-2, and nodes 614 in the second hidden layer 610-2 are connected to nodes 616 in the output layer 608). Each of the nodes (612, 614 and 616) sum up the values from adjacent nodes and apply an activation function, allowing the neural network model 600 to detect nonlinear patterns in the inputs 602. Each of the nodes (612, 614 and 616) are interconnected by weights 620-1, 620-2, 620-3, 620-4, 620-5, 620-6 (collectively referred to as weights 620). Weights 620 are tuned during training to adjust the strength of the node. The adjustment of the strength of the node facilitates the neural network's ability to predict an accurate output 606 (e.g., protection and strategy responses).

In some embodiments, the output 606 may be one or more numbers. For example, output 606 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to provide independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc.

Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
training, by one or more processors, a plurality of protection models of an entity using a training input to output a plurality of protection responses, wherein training comprises:
receiving a plurality of entity datasets of a plurality of entities, the plurality of entity datasets corresponding to one or more protection parameters for at least one of the plurality of entities;
generating an entity protection model of the plurality of protection models to generate a plurality of entity protection responses for a plurality of exchanges, the entity protection model trained using, as a first input, the one or more protection parameters of a first entity of the plurality of entities;
generating one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities;
generating one or more entity sector models of the plurality of protection models to generate a plurality of second strategy responses, the one or more entity sector models trained using, as a third input, a second subset of entities of the plurality of entities satisfying a sector parameter or a cross-sector parameter;
receiving, by the one or more processors, exchange data of an exchange of the first entity of the plurality of entities;
modeling, by the one or more processors using the entity protection model, the exchange data and third-party data to generate an entity protection response corresponding to the exchange;
providing, by the one or more processors, the entity protection response corresponding to the exchange to an entity computing system of the first entity;
receiving, by the one or more processors, a feedback response to the entity protection response from the entity computing system;
updating, by the one or more processors, the entity protection model based on the feedback response; and
updating, by the one or more processors, at least one of the one or more entity relationship models or the one or more entity sector models based on the feedback response.

2. The method of claim 1, further comprising:
modeling, by the one or more processors using the one or more entity relationship models, the one or more protection parameters of the first entity to generate a first strategy response corresponding with a first update to the one or more protection parameters; and
providing, by the one or more processors, the first strategy response to the entity computing system.

3. The method of claim 1, further comprising:
modeling, by the one or more processors using the one or more entity sector models, the one or more protection parameters of the first entity to generate a second strategy response corresponding with a second update to the one or more protection parameters; and
providing, by the one or more processors, the second strategy response to the entity computing system.

4. The method of claim 1, further comprising:
receiving, by the one or more processors, a model creation request corresponding with the first entity;
capturing and accessing, by the one or more processors using a plurality of data channels of the first entity, protection information and security information of the first entity;
identifying, by the one or more processors, the one or more protection parameters of the first entity based on the protection information and security information of the first entity; and
wherein the first input used in training of the entity protection model further comprises the protection information and security information.

5. The method of claim 1, wherein the one or more protection parameters correspond to entity governance rules, protection management rules, security compliance standards, and operational integrity protocols of the first entity.

6. The method of claim 1, wherein the entity protection response is a protection index corresponding to a quantification of security vulnerabilities of the exchange.

7. The method of claim 1, further comprising:
receiving, by the one or more processors, additional exchange data of a second exchange of the first entity of the plurality of entities;
modeling, by the one or more processors using the updated entity protection model, the additional exchange data and the third-party data to generate a second entity protection response corresponding to the second exchange; and
providing, by the one or more processors, the second entity protection response corresponding to the second exchange to the entity computing system of the first entity.

8. The method of claim 1, wherein providing comprises at least one of:
transmitting, using a first communication protocol, the entity protection response to a webhook of a third-party application of a third-party;
transmitting, using a second communication protocol, the entity protection response to an event listener of the third-party application of the third-party; and
loading the entity protection response into a shared storage system for retrievable by a pooling system of the third-party.

9. The method of claim 1, wherein the feedback response further comprises an additional information request, and wherein the method further comprising:
generating, using a generative AI (GAI) model, a GAI response comprising an entity protection response report based on inputting the entity protection response, the exchange data, and the third-party data, wherein the GAI response is based at least on inputting the exchange data and the third-party data into at least one of the one or more entity relationship models or the one or more entity sector models.

10. A system comprising:
a processing circuit comprising one or more processors and memory storing instructions that, when executed, cause the processing circuit to:
train a plurality of protection models of an entity using a training input to output a plurality of protection responses, wherein training comprises:
receiving a plurality of entity datasets of a plurality of entities, the plurality of entity datasets corresponding to one or more protection parameters for at least one of the plurality of entities;
generating an entity protection model of the plurality of protection models to generate a plurality of entity protection responses for a plurality of exchanges, the entity protection model trained using, as a first input, the one or more protection parameters of a first entity of the plurality of entities;
generating one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities;
generating one or more entity sector models of the plurality of protection models to generate a plurality of second strategy responses, the one or more entity sector models trained using, as a third input, a second subset of entities of the plurality of entities satisfying a sector parameter or a cross-sector parameter;
receive exchange data of an exchange of the first entity of the plurality of entities;
model, using the entity protection model, the exchange data and third-party data to generate an entity protection response corresponding to the exchange;
provide the entity protection response corresponding to the exchange to an entity computing system of the first entity;
receive a feedback response to the entity protection response from the entity computing system;
update the entity protection model based on the feedback response; and
update at least one of the one or more entity relationship models or the one or more entity sector models based on the feedback response.

11. The system of claim 10, wherein the instructions further cause the processing circuit to:
model, using the one or more entity relationship models, the one or more protection parameters of the first entity to generate a first strategy response corresponding with a first update to the one or more protection parameters; and
provide the first strategy response to the entity computing system.

12. The system of claim 10, wherein the instructions further cause the processing circuit to:
model, using the one or more entity sector models, the one or more protection parameters of the first entity to generate a second strategy response corresponding with a second update to the one or more protection parameters; and
provide the second strategy response to the entity computing system.

13. The system of claim 10, wherein the instructions further cause the processing circuit to:
receive a model creation request corresponding with the first entity;
capture and access, using a plurality of data channels of the first entity, protection information and security information of the first entity;
identify the one or more protection parameters of the first entity based on the protection information and security information of the first entity; and
wherein the first input used in training of the entity protection model further comprises the protection information and security information.

14. The system of claim 10, wherein the one or more protection parameters correspond to entity governance rules, protection management rules, security compliance standards, and operational integrity protocols of the first entity.

15. The system of claim 10, wherein the entity protection response is a protection index corresponding to a quantification of security vulnerabilities of the exchange.

16. The system of claim 10, wherein the instructions further cause the processing circuit to:
receive additional exchange data of a second exchange of the first entity of the plurality of entities;
model, using the updated entity protection model, the additional exchange data and the third-party data to generate a second entity protection response corresponding to the second exchange; and
provide the second entity protection response corresponding to the second exchange to the entity computing system of the first entity.

17. The system of claim 10, wherein providing comprises at least one of:
transmitting, using a first communication protocol, the entity protection response to a webhook of a third-party application of a third-party;
transmitting, using a second communication protocol, the entity protection response to an event listener of the third-party application of the third-party; and
loading the entity protection response into a shared storage system for retrievable by a pooling system of the third-party.

18. The system of claim 10, wherein the feedback response further comprises an additional information request, and wherein the instructions further cause the processing circuit to:
generating, using a generative AI (GAI) model, a GAI response comprising an entity protection response report based on inputting the entity protection response, the exchange data, and the third-party data, wherein the GAI response is based at least on inputting the exchange data and the third-party data into at least one of the one or more entity relationship models or the one or more entity sector models.

19. A method, comprising:
training, by one or more processors, a plurality of protection models of an entity using a training input to output a plurality of protection responses,
receiving, by the one or more processors, exchange data of an exchange of a first entity of a plurality of entities;
modeling, by the one or more processors using an entity protection model, the exchange data and third-party data to generate an entity protection response corresponding to the exchange;
modeling, by the one or more processors using at least one of an entity relationship model or an entity sector model, the exchange data and third-party data to generate a strategy response;
providing, by the one or more processors, the entity protection response and the strategy response corresponding to the exchange to an entity computing system of the first entity;
receiving, by the one or more processors, a feedback response to the entity protection response or the strategy response from the entity computing system; and
updating, by the one or more processors, at least one of the entity protection model, the entity relationship model, or the entity sector model, based on the feedback response.

20. The method of claim 19, wherein training further comprises:
receiving a plurality of entity datasets of the plurality of entities, the plurality of entity datasets corresponding to one or more protection parameters for at least one of the plurality of entities;
generating the entity protection model of the plurality of protection models to generate a plurality of entity protection responses for a plurality of exchanges, the entity protection model trained using, as a first input, the one or more protection parameters of the first entity of the plurality of entities;
generating the one or more entity relationship models of the plurality of protection models to generate a plurality of first strategy responses, the one or more entity relationship models trained using, as a second input, a first subset of entities of the plurality of entities based on a common attribute or an equivalent attribute of the first subset of entities; and
generating the one or more entity sector models of the plurality of protection models to generate a plurality of second strategy responses, the one or more entity sector models trained using, as a third input, a second subset of entities of the plurality of entities satisfying a sector parameter or a cross-sector parameter.
